(19) United States
(12) Patent Application Publication
(10) Pub. No.: US 2007/0093734 A1
(43) Pub. Date: Apr. 26, 2007

(54) Massaging cushion

(76) Inventor: Hung-Chang Chen, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/257,469

(22) Filed: Oct. 25, 2005

(51) Int. Cl. A61H 7/00

(52) U.S. Cl. 601/99; 601/101; 601/103

(57) ABSTRACT

A massaging cushion includes a base, a massaging device, a displacement device, at least one positioning switch, a front seat, a controller, and an electric plug. Thus, the massaging cushion is an individual body, so that the massaging cushion is directly mounted on a seat of a car without having to detach the seat of the car and without having to buy a massaging seat especially, thereby decreasing costs of fabrication and assembly of the massaging cushion. In addition, the massaging cushion is directly mounted on the seat of a vehicle so that the massaging cushion is available for vehicles of different kinds, thereby enhancing the versatility of the massaging cushion.

### BACKGROUND OF THE INVENTION

1. Field of the Invention

The present invention relates to a massaging cushion, and more particularly to a massaging cushion for a seat of a vehicle, such as a car or the like.

2. Description of the Related Art

A conventional massaging seat especially designed for a car comprises a backrest, and a massaging device mounted in the backrest. The massaging device is driven by the electric power supplied by the car, so that the massaging device is rolled and moved to provide a massaging effect to a driver's back rested on the backrest. However, it is necessary to detach the original seat of the car and to mount the massaging seat onto the car, thereby causing inconvenience to the user in assembly of the massaging seat. In addition, the massaging seat has an expensive price, thereby increasing costs of fabrication. Further, the whole car needs to be repaired when the massaging seat is inoperative, thereby causing inconvenience to the user.

### SUMMARY OF THE INVENTION

In accordance with the present invention, there is provided a massaging cushion, comprising:

a base having a mediate portion provided with a protruding slide track having a side provided with at least one switch receiving seat;

a massaging device including a frame, a motor, at least one rotation member, at least one massaging ball, a push member, and at least one roller;

a displacement device including at least one drive gear, a connecting gear, a displacement gear, and a rack;

at least one positioning switch that is a contact switch;

a front seat having an inside formed with a displacement slot and having a mediate portion formed with a guide track;

a controller provided with a plurality of push buttons to control displacement and operation of the massaging device; and

an electric plug;

wherein, the rack of the displacement device is secured to a side of the base, the displacement gear of the displacement device meshes with the rack of the displacement device, the drive gear of the displacement device has a shaft extended through the frame of the massaging device and secured to the rotation member of the massaging device, the connecting gear of the displacement device meshes with the drive gear and the displacement gear of the displacement device, the drive gear of the displacement device is engaged with a threaded section of the motor of the massaging device, the frame of the massaging device is mounted on the slide track of the base, the positioning switch is mounted on the switch receiving seat of the base, the push member of the massaging device is movable to contact the positioning switch, the front seat is locked on the base, so that the roller on the frame of the massaging device is mounted in the guide track of the front seat, and the rotation member and the massaging ball of the massaging device are extended through the displacement slot of the front seat respectively.

The primary objective of the present invention is to provide a massaging cushion that is directly mounted on a seat of a vehicle, such as a car or the like.

Another objective of the present invention is to provide a massaging cushion, wherein the massaging cushion is an individual body, so that the massaging cushion is directly mounted on a seat of a car without having to detach the seat of the car and without having to buy a massaging seat especially, thereby decreasing costs of fabrication and assembly of the massaging cushion.

A further objective of the present invention is to provide a massaging cushion, wherein the massaging cushion is directly mounted on the seat of a vehicle so that the massaging cushion is available for vehicles of different kinds, thereby enhancing the versatility of the massaging cushion.

Further benefits and advantages of the present invention will become apparent after a careful reading of the detailed description with appropriate reference to the accompanying drawings.

### BRIEF DESCRIPTION OF THE DRAWINGS

FIG. 1 is a partially exploded perspective view of a massaging cushion in accordance with the preferred embodiment of the present invention.

FIG. 2 is a plan cross-sectional view of the massaging cushion as shown in FIG. 1.

FIG. 3 is a side plan cross-sectional assembly view of the massaging cushion as shown in FIG. 1.

FIG. 4 is a schematic operational view of the massaging cushion as shown in FIG. 3 in use.

### DETAILED DESCRIPTION OF THE INVENTION

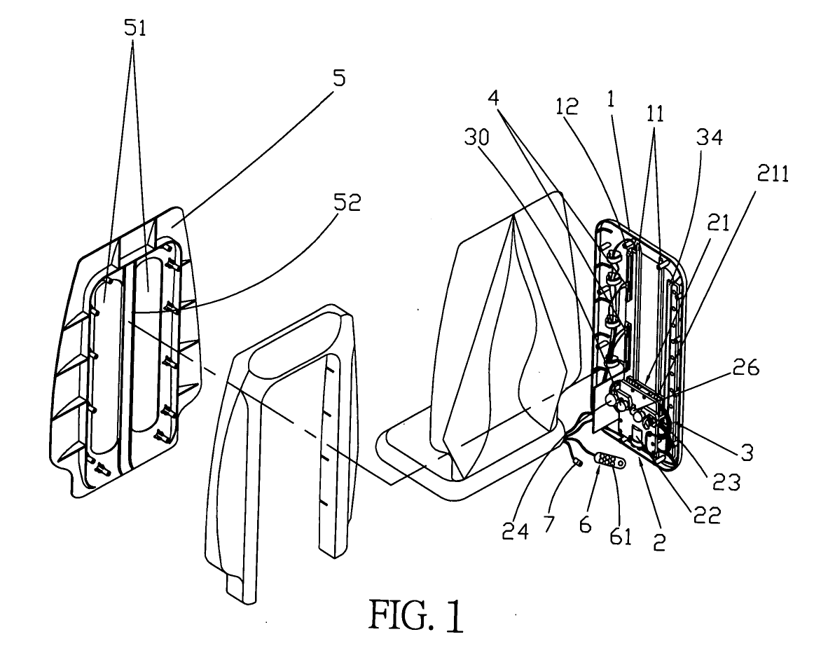

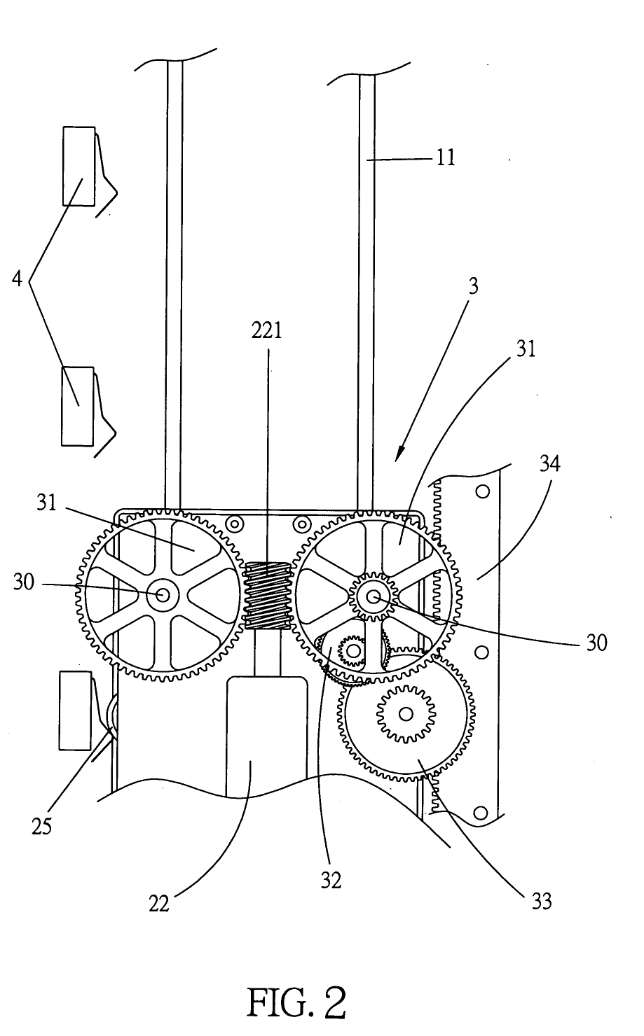

Referring to the drawings and initially to FIGS. 1-3, a massaging cushion in accordance with the preferred embodiment of the present invention comprises a base 1, a massaging device 2, a displacement device 3, at least one positioning switch 4, a front seat 5, a controller 6, and an electric plug 7.

The base 1 has a mediate portion provided with a protruding slide track 11 having a side provided with at least one switch receiving seat 12.

The massaging device 2 includes a frame 21, a motor 22, at least one rotation member 23, at least one massaging ball 24, a push member 25, and at least one roller 26. The frame 21 has a bottom formed with a slideway 211. The push member 25 of the massaging device 2 is protruded outward from a side of the frame 21. The roller 26 is axially mounted on a mediate portion of an upper end of the frame 21. The motor 22 has a front end formed with a threaded section 221. The massaging ball 24 of the massaging device 2 is mounted on the rotation member 23 of the massaging device 2.

The displacement device 3 includes at least one drive gear 31, a connecting gear 32, a displacement gear 33, and a rack 34.

The positioning switch 4 is a contact switch.

The front seat 5 has an inside formed with a displacement slot 51 and has a mediate portion formed with a guide track 52.

The controller 6 is provided with a plurality of push buttons 61 to control displacement and operation of the massaging device 2.

The electric plug 7 is directly connected to a power supply, such as a cigarette lighter in the car.

In assembly, the rack 34 of the displacement device 3 is secured to a side of the base 1. The displacement gear 33 of the displacement device 3 meshes with the rack 34 of the displacement device 3. The drive gear 31 of the displacement device 3 has a shaft 30 extended through the upper end of the frame 21 of the massaging device 2 and secured to the rotation member 23 of the massaging device 2. The connecting gear 32 of the displacement device 3 is located between and meshing with the drive gear 31 and the displacement gear 33 of the displacement device 3. The drive gear 31 of the displacement device 3 is engaged with the threaded section 221 of the motor 22 of the massaging device 2. The slideway 211 of the frame 21 of the massaging device 2 is mounted on the slide track 11 of the base 1, so that the frame 21 of the massaging device 2 is slidable on the slide track 11 of the base 1. The positioning switch 4 is mounted on the switch receiving seat 12 of the base 1. The push member 25 of the massaging device 2 is movable to contact the positioning switch 4. The front seat 5 is locked on the base 1, so that the roller 26 on the frame 21 of the massaging device 2 is mounted in the guide track 52 of the front seat 5, and the rotation member 23 and the massaging ball 24 of the massaging device 2 are extended through the displacement slot 51 of the front seat 5 respectively.

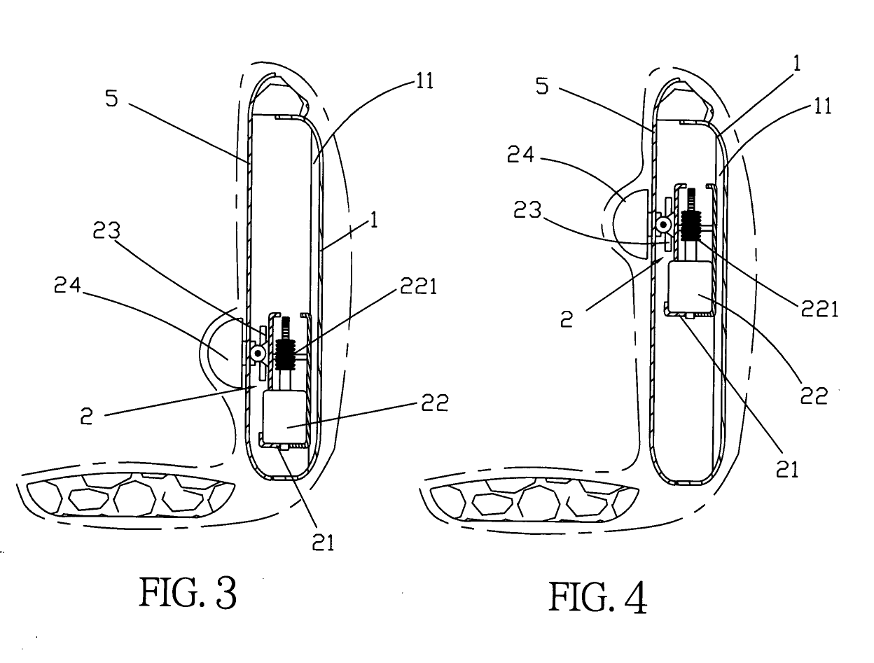

Referring to FIGS. 1-4, the electric plug 7 is directly inserted into the cigarette lighter in the car. Then, the motor 22 of the massaging device 2 is set and started by pressing the push buttons 61 of the controller 6 to rotate the threaded section 221 which rotates the drive gear 31 which rotates the connecting gear 32 which rotates the displacement gear 33. At this time, the displacement gear 33 meshes with the rack 34, so that the displacement gear 33 is movable on the rack 34 when the displacement gear 33 is rotated to push and move the massaging device 2, so that the massaging device 2 is movable relative to the base 1. In addition, the slideway 211 of the frame 21 of the massaging device 2 is mounted on the slide track 11 of the base 1, and the roller 26 on the frame 21 of the massaging device 2 is mounted in the guide track 52 of the front seat 5, so that the massaging device 2 is slidable on the slide track 11 of the base 1 smoothly. In addition, the rotation member 23 of the massaging device 2 is secured to the drive gears 31 of the displacement device 3, so that the rotation member 23 of the massaging device 2 is rotated and moved with the drive gears 31 of the displacement device 3 to drive the massaging ball 24 to rotate and move relative to the front seat 5 as shown in FIGS. 3 and 4, thereby providing a massaging effect to a driver in the car. In addition, the massaging position and angle of the massaging ball 24 are set by pressing the push buttons 61 of the controller 6, so that when the massaging device 2 is moved to the preset position or height, the push member 25 of the massaging device 2 is movable to contact the positioning switch 4 to locate the massaging device 2 at the fixed position or to drive the massaging device 2 to move in another direction.

Accordingly, the massaging cushion is an individual body, so that the massaging cushion is directly mounted on a seat of a car without having to detach the seat of the car and without having to buy a massaging seat especially, thereby decreasing costs of fabrication and assembly of the massaging cushion. In addition, the massaging cushion is directly mounted on the seat of a vehicle so that the massaging cushion is available for vehicles of different kinds, thereby enhancing the versatility of the massaging cushion.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A massaging cushion, comprising:
a base having a mediate portion provided with a protruding slide track having a side provided with at least one switch receiving seat;
a massaging device including a frame, a motor, at least one rotation member, at least one massaging ball, a push member, and at least one roller;
a displacement device including at least one drive gear, a connecting gear, a displacement gear, and a rack;
at least one positioning switch that is a contact switch;
a front seat having an inside formed with a displacement slot and having a mediate portion formed with a guide track;
a controller provided with a plurality of push buttons to control displacement and operation of the massaging device; and
an electric plug;
wherein, the rack of the displacement device is secured to a side of the base, the displacement gear of the displacement device meshes with the rack of the displacement device, the drive gear of the displacement device has a shaft extended through the frame of the massaging device and secured to the rotation member of the massaging device, the connecting gear of the displacement device meshes with the drive gear and the displacement gear of the displacement device, the drive gear of the displacement device is engaged with a threaded section of the motor of the massaging device, the frame of the massaging device is mounted on the slide track of the base, the positioning switch is mounted on the switch receiving seat of the base, the push member of the massaging device is movable to contact the positioning switch, the front seat is locked on the base, so that the roller on the frame of the massaging device is mounted in the guide track of the front seat, and the rotation member and the massaging ball of the massaging device are extended through the displacement slot of the front seat respectively.

2. The massaging cushion in accordance with claim 1, wherein the frame of the massaging device has a bottom formed with a slideway mounted on the slide track of the base.

3. The massaging cushion in accordance with claim 1, wherein the push member of the massaging device is protruded outward from a side of the frame of the massaging device.

4. The massaging cushion in accordance with claim 1, wherein the roller is axially mounted on a mediate portion of an upper end of the frame of the massaging device.

5. The massaging cushion in accordance with claim 1, wherein the motor has a front end formed with the threaded section.

6. The massaging cushion in accordance with claim 1, wherein the massaging ball of the massaging device is mounted on the rotation member of the massaging device.

7. The massaging cushion in accordance with claim 1, wherein the connecting gear of the displacement device is located between and meshing with the drive gear and the displacement gear of the displacement device.

8. The massaging cushion in accordance with claim 1, wherein the displacement gear of the displacement device meshes with the rack of the displacement device, so that the displacement gear is movable on the rack when the displacement gear is rotated to push and move the massaging device, so that the massaging device is movable relative to the base.
